(19) United States
(12) Patent Application Publication
(10) Pub. No.: US 2025/0079753 A1
(43) Pub. Date: Mar. 6, 2025

(54) ELECTRICAL CONNECTOR ASSEMBLY

(71) Applicant: Molex, LLC, Lisle, IL (US)

(72) Inventors: Yong-Chao Li, Shanghai (CN); Hao Yin, Shanghai (CN); Da-Li Yuan, Shanghai (CN)

(21) Appl. No.: 18/809,382

(22) Filed: Aug. 20, 2024

(30) Foreign Application Priority Data
Aug. 28, 2023 (CN) 202311092816.7

(51) Int. Cl. H01R 13/52; H01R 13/24

(52) U.S. Cl. CPC H01R 13/521; H01R 13/2421

(57) ABSTRACT

An electrical connector assembly including an elastic waterproof member and at least one electrical connector provided to the elastic waterproof member, the electrical connector includes: a contact member partially exposed to a first side of the elastic waterproof member along a first direction, the contact member is integrated with the elastic waterproof member; a supporting element provided to a second side of the elastic waterproof member along the first direction, the supporting element and the contact member are fixed together and establish an electrical connection; a conductive base including at least one elastic contact arm, the elastic contact arm and the supporting element slidably contact each other to form an electrical connection; and an elastic driving member provided between the conductive base and the supporting element, the contact member and the supporting element are capable of moving along the first direction relative to the conductive base by means of the elastic driving member. The electrical connector assembly may efficiently promote waterproof performance and use reliability of the electrical connector.

### TECHNICAL FIELD

The present disclosure relates to the technical field of electrical connectors, and specifically relates to an electrical connector assembly.

### BACKGROUND

With development of various electronic devices, application of electrical connector assemblies is increasingly wide. Chinese patent document CN113871945A discloses an electrical connector which includes a pin, a barrel, a coil spring and an insulator. The barrel sheathes a part of the pin, the coil spring is positioned in the barrel and is positioned between the pin and a bottom wall of the barrel, the pin may move along an axial direction of the barrel. The pin is sheathed thereon with the insulator, the insulator and an outer wall surface of the pin interference fit to seal a gap between the insulator and the pin. However, the insulator will move up and down together with the pin, the insulator cannot retain sealing a gap between the pin and a first casing under a vibrating circumstance, which has a risk that external water droplet inwardly permeates into an electronic device. And because the pin and the barrel employ a collide-type contact therebetween, a contact resistance is larger, when vibration is generated, a problem that the pin and the barrel poor contact poorly to cause the electrical connection to generate instant break may occur, therefore it needs to be further improved.

### SUMMARY

With respect to the problem in the prior art, an object of the present disclosure is to provide an electrical connector assembly which efficiently promotes waterproof performance and use reliability of an electrical connector.

Embodiments of the present disclosure provides an electrical connector assembly comprising an elastic waterproof member and at least one electrical connector provided to the elastic waterproof member, the electrical connector comprises: a contact member partially exposed to a first side of the elastic waterproof member along a first direction, the contact member is integrated with the elastic waterproof member; a supporting element provided to a second side of the elastic waterproof member along the first direction, the supporting element and the contact member are fixed together and establish an electrical connection; a conductive base comprising at least one elastic contact arm, the elastic contact arm and the supporting element slidably contact each other to form an electrical connection; and an elastic driving member provided between the conductive base and the supporting element, the contact member and the supporting element are capable of moving along the first direction relative to the conductive base by means of the elastic driving member.

In some embodiment, the conductive base comprises a base body, the base body is provided to a side of the supporting element away from the contact member, the elastic driving member is provided between the base body and the supporting element; the elastic contact arm is connected to the base body, and extends toward the supporting element relative to the base body.

In some embodiment, the at least one elastic contact arm are two elastic contact arms, the two elastic contact arms respectively clamp two opposite sides of the supporting element.

In some embodiment, the electrical connector assembly further comprises a circuit board, a connecting leg further extends out from the base body, the base body is electrically connected with the circuit board via the connecting leg.

In some embodiment, the circuit board is provided with a receiving hole, at least a part of the conductive base is positioned in the receiving hole, the connecting leg extends toward an outer side of the base body relative to the base body.

In some embodiment, the conductive base is integrally formed by stamping a metal sheet, the base body is provided with a positioning portion which protrudes upwardly at a position of the base body corresponding to the elastic driving member, the positioning portion is used to cooperate with and position the elastic driving member.

In some embodiment, the supporting element is provided with a first receiving groove and a second receiving groove, at least a part of the contact member is positioned in the first receiving groove, at least a part of the elastic driving member is positioned in the second receiving groove.

In some embodiment, the contact member comprises a contact portion which is positioned to the first side and is dome-shaped and a post which is positioned to the second side, a first side of the supporting element forms a first receiving groove, at least a part of the post of the contact member is positioned in the first receiving groove.

In some embodiment, an outer edge of the contact portion expands outwardly to form a mounting portion, the contact portion and the post is further provided therebetween with a neck portion which is recessed inwardly, the elastic waterproof member is filled to an outer periphery of the neck portion.

In some embodiment, the contact portion and the post of the contact member is further provided therebetween with a first step portion, the first step portion presses against the first side of the supporting element.

In some embodiment, the contact portion and the post of the contact member is further provided therebetween with a first step portion, the first receiving groove comprises an opening section whose inner diameter is larger and a receiving section whose inner diameter is smaller, the opening section is positioned to a first side of the receiving section, the first step portion presses against a bottom surface of the opening section, the post is tightly fixed to the receiving section.

In some embodiment, an inner wall of the opening section and the first step portion form a first gap in a radial direction, the elastic waterproof member comprises a protruding portion which is positioned in the first gap.

In some embodiment, a first side of the supporting element abuts against the elastic waterproof member.

In some embodiment, the elastic waterproof member comprises a plurality of U-shaped elastic extending portions, the plurality of elastic extending portions are positioned to an outer side of the electrical connector.

In some embodiment, the electrical connector assembly further comprises an outer casing, the elastic waterproof member is fixed to an outer surface of the outer casing, at least a part of the electrical connector is positioned inside the outer casing, the supporting element is provided with a second step portion, the outer casing is provided with a limiting portion which faces the second step portion, and the limiting portion is positioned to a side of the second step portion which is toward the contact member.

The electrical connector assembly provided by the present disclosure has following advantages: in the present disclosure, by that the elastic waterproof member is provided on an exterior of electrical connector, the elastic waterproof member is integrated with the contact member of the electrical connector, and the elastic waterproof member may generate elastic deformation to accommodate movement of the contact member, the elastic waterproof member may be mounted on an outer casing of an electronic device, it efficiently prevents water droplet from permeating into an interior of the electronic device and an interior of the electrical connector via a gap between the contact member and the elastic waterproof member, and realizes good waterproof effect, at the same time, the elastic contact arm of the conductive base and the supporting element elastic contact together, it may establish a good electrical connection, prevent contact from being poor during vibration to cause occurring of instant break, and efficiently promote use stability and reliability of the electrical connector assembly.

### BRIEF DESCRIPTION OF THE DRAWINGS

Other features, objects, and advantages of the present disclosure will become more apparent by reviewing the detailed description on non-limiting embodiments with reference to the accompanying drawings.

FIG. 1 is a structure schematic view of an electrical connector assembly of a first embodiment of the present disclosure;

FIG. 2 is a top view of the electrical connector assembly of the first embodiment of the present disclosure;

FIG. 3 is a cross sectional view along a line A1-A1 of FIG. 2;

FIG. 4 is a schematic view of the electrical connector assembly of the first embodiment of the present disclosure with an outer casing omitted;

FIG. 5 is a schematic view of cooperation among a supporting element, a conductive base and a circuit board of the first embodiment of the present disclosure;

FIG. 6 is an exploded view of the electrical connector assembly of the first embodiment of the present disclosure with the outer casing omitted;

FIG. 7 is a structure schematic view of an electrical connector of the first embodiment of the present disclosure;

FIG. 8 and FIG. 9 are exploded views of the individual electrical connector of the first embodiment of the present disclosure;

FIG. 10 is a partial cross sectional view of an electrical connector assembly of a second embodiment of the present disclosure with an outer casing omitted;

FIG. 11 is an exploded view of an individual electrical connector of the second embodiment of the present disclosure;

FIG. 12 is a partial cross sectional view of an electrical connector assembly of a third embodiment of the present disclosure with an outer casing omitted;

FIG. 13 is a schematic view of cooperation among an elastic waterproof member, a contact member and a supporting element of the third embodiment of the present disclosure;

FIG. 14 is a partial cross sectional view of an electrical connector assembly of a fourth embodiment of the present disclosure with an outer casing omitted;

FIG. 15 is a cross sectional view of a supporting element of the fourth embodiment of the present disclosure;

FIG. 16 is a schematic view of cooperation among an elastic waterproof member, a contact member and the supporting element of the fourth embodiment of the present disclosure.

### DETAILED DESCRIPTION

The example implementations will now be described more comprehensively with reference to the accompanying drawings. However, the example embodiments can be implemented in various forms and should not be understood as limited to the implementations described herein; on the contrary, providing these implementations makes that the present disclosure will be comprehensive and complete, and fully conveys the concept of the example implementations to those skilled in the art. The same reference numerals in the figures indicate the same or similar structures, so repeated descriptions thereof will be omitted. “Or” in the description may indicate “and” or “or”. Although the terms “up”, “down”, “between”, etc. may be used in the description to describe different exemplary features and elements of the present disclosure, these terms are used only for convenience herein, for example, are based on the example directions in the accompanying drawings. Any content of the description should not be understood that a specific three-dimensional orientation of the structure is required to be fallen within the scope of the present disclosure. Although the terms “first” or “second” are used in the description to represent certain features, they are only intended for indication and do not serve as limitations on the number and importance of the specific features.

The present disclosure provides an electrical connector assembly including an elastic waterproof member and at least one electrical connector provided to the elastic waterproof member, the electrical connector includes a contact member, a supporting element, a conductive base and an elastic driving member. The contact member is partially exposed to a first side of the elastic waterproof member along a first direction, and the contact member is integrated with the elastic waterproof member. Therefore, in the present disclosure, by that the elastic waterproof member which may be mounted on an outer casing of an electronic device is provided on an exterior of the electrical connector, the elastic waterproof member is integrated with the contact member of the electrical connector, and the elastic waterproof member may generate elastic deformation to accommodate movement of the contact member, it efficiently prevents water droplet from permeating into an interior of the electronic device and an interior of the electrical connector via a gap between the contact member and the elastic waterproof member, and realizes good waterproof effect.

The supporting element is provided to a second side of the elastic waterproof member along the first direction, and the supporting element and the contact member are fixed together and establish an electrical connection. The conductive base includes at least one elastic contact arm, the elastic contact arm and the supporting element slidably contact each other to form an electrical connection. The elastic driving member is provided between the conductive base and the supporting element. The contact member and the supporting element is capable of sliding along the first direction relative to the conductive base by means of the elastic driving member. Therefore, the elastic contact arm of the conductive base and the supporting element elastic contact together, it may establish a good electrical connection, prevent contact from being poor during vibration to cause instant break, and efficiently promote use stability and reliability of the electrical connector assembly.

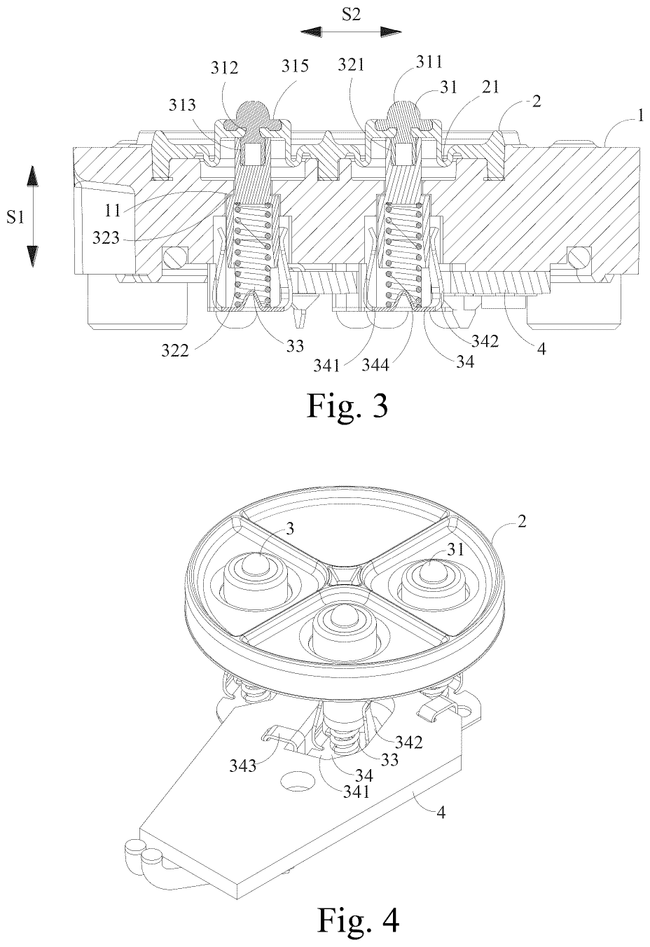

Hereinafter a structure of an electrical connector assembly of each specific embodiment is introduced in connection with the drawings. It may be understood that, the drawings and the following description are only exemplary, and do not act as limiting on the protective scope of the present disclosure. In the present disclosure, a first direction refers to a S1 direction of a view angle of FIG. 3, i.e. an up-down direction, a width direction refers to a S2 direction of the view angle of FIG. 3, i.e. a left-right direction, in the view angle of FIG. 3, the width direction S2 also is a radial direction of a post of a contact member.

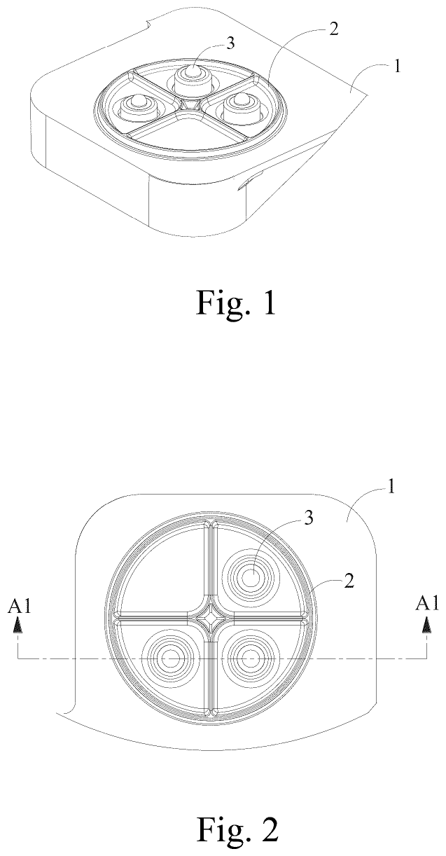

FIG. 1 to FIG. 9 illustrate an electrical connector assembly of a first embodiment of the present disclosure. As shown in FIG. 1 to FIG. 4, the electrical connector assembly includes an outer casing 1 of an electronic device, an elastic waterproof member 2, a circuit board 4 and at least one electrical connector 3 provided to the elastic waterproof member 2. The elastic waterproof member 2 is fixed to a surface of the outer casing 1, most of the electrical connector 3 is positioned inside the outer casing 1. The elastic waterproof member 2 includes a first side and a second side along the first direction, in the view angle of FIG. 3, the first side and the second side of the elastic waterproof member 2 respectively correspond to an upper side and a lower side of the elastic waterproof member 2. The electrical connector 3 includes a contact member 31, a supporting element 32 and a conductive base 34. The contact member 31 includes a contact portion 311 which is positioned to the first side and is dome-shaped and a post 313 which is positioned to the second side, the post 313 preferably is a hollow post 313. An upper portion of the contact portion 311 is exposed to the upper side of the elastic waterproof member 2. The supporting element 32 provided to the lower side of the elastic waterproof member 2, and the supporting element 32 and the contact member 31 are fixed together and establish an electrical connection. The conductive base 34 includes at least one elastic contact arm 342 which extends upwardly, the elastic contact arm 342 and the supporting element 32 slidably contact each other to form an electrical connection. The elastic waterproof member 2 of the first embodiment is provided thereon with the three electrical connectors 3, but the present disclosure is not limited thereto, the number of the electrical connector 3 also may be one, two or more than three.

The contact member 31 is integrated with the elastic waterproof member 2, to form a sealing interface which blocks water and an external foreign matter to enter an interior of the electrical connector 3 or an interior of the outer casing 1. Specifically, the contact member 31 and the elastic waterproof member 2 are engaged together by an insert molding process, a pressing-fit process or an adhering process. For example, the contact member 31 is placed into a molding mold of the elastic waterproof member 2 in advance, a molten plastic material is injected into the molding mold, is cooled down to obtain a component, i.e. the contact member 31 is integrated with the elastic waterproof member 2. Such a manner may realize tight cooperation between the contact member 31 and the elastic waterproof member 2. In other alternative implementing manners, the contact member 31 also may be pressed into the elastic waterproof member 2 which have been molded, or an adhesive is applied between an outer periphery of the contact member 31 and the elastic waterproof member 2 to adhere the contact member 31 and the elastic waterproof member 2 together. After the contact member 31 and the elastic waterproof member 2 are engaged with each other, the contact member 31 and the elastic waterproof member 2 may be assembled with the supporting element 32 together.

The elastic waterproof member 2 for example may be made of a material which has a certain elasticity, such as a silica gel, a plastic and the like. By that the elastic waterproof member 2 is provided to an exterior of the outer casing 1 of the electronic device, the elastic waterproof member 2 is integrated with the contact member 31 of the electrical connector 3, and the elastic waterproof member 2 may generate an elastic deformation to accommodate movement of the contact member 31, it efficiently prevent a water droplet from permeating into the interior of the electronic device and the interior of the electrical connector 3 via a gap between the contact member 31 and the elastic waterproof member 2, realize good waterproof effect. The elastic waterproof member 2 and the outer casing 1 may be pressed fit or adhered together, so it also may avoid a water droplet entering the interior of the electronic device and the interior of the electrical connector 3 via the gap between the elastic waterproof member 2 and the outer casing 1, further promote the waterproof effect of the electrical connector assembly.

As shown in FIG. 3 to FIG. 5, the supporting element 32 and the conductive base 34 is further provided therebetween with an elastic driving member 33, the elastic driving member 33 is configured to provide a biasing force, which is toward the up, for the supporting element 32, to make press contact of the contact member 31 with another mating member (not shown, which may be a conductive metal post) tighter, realize electrical conduction function, the contact member 31 and the supporting element 32 may move along the first direction relative to the conductive base 34 by means of the elastic driving member 33. An upper side of the supporting element 32 is provided with a first receiving groove 321, a lower side of the supporting element 32 is provided with a second receiving groove 322. The first receiving groove 321 is used to receive the post 313 of the contact member 31, the post 313 may form an interference fit with the first receiving groove 321 so that the post 313 is tightly fixed in the first receiving groove 321, a lower side of the post 313 abuts against a bottom wall of the first receiving groove 321. The second receiving groove 322 is used to receive the elastic driving member 33. The elastic driving member 33 is a coil spring, in other implementing manners, the elastic driving member 33 also may be other elastic component, for example, a plate spring, an elastic pad and the like. As shown in FIG. 3, the supporting element 32 is provided with a second step portion 323, the outer casing 1 is provided with a limiting portion 11 which faces the second step portion 323, and the limiting portion 11 is positioned above the second step portion 323. The limiting portion 11 may limit a stroke that the supporting element 32 moves upwardly to prevent the supporting element 32 from upwardly leaving out the casing 1.

As shown in FIG. 3, the elastic waterproof member 2 includes a plurality of elastic extending portions 21 which extend downwardly, the plurality of elastic extending portions 21 are positioned to an outer side of the electrical connector 3. The elastic extending portion 21 is formed as a U-shape, may function as elastically supporting the contact member 31 to provide a space for the contact member 31 to elastically move up and down.

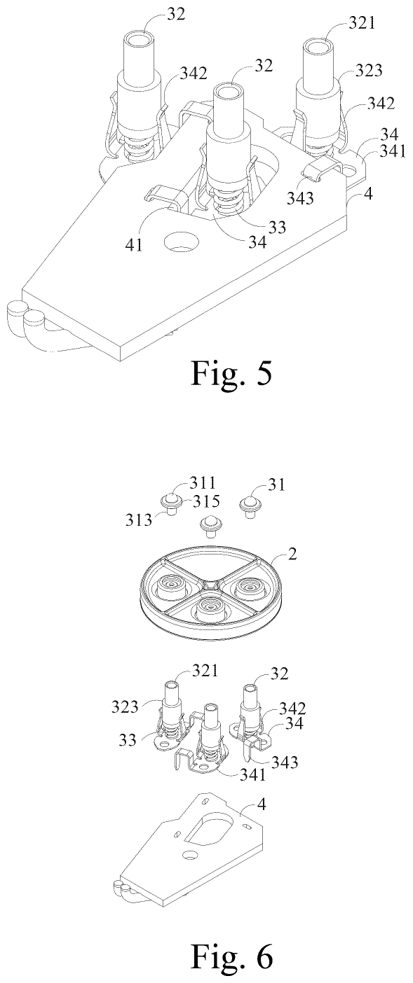

As shown in FIG. 5 to FIG. 9, the circuit board 4 is provided therein with a receiving hole 41, at least a part of the conductive base 34 is positioned in the receiving hole 41. The conductive base 34 includes a base body 341, the base body 341 is provided to the lower side of the supporting element 32, an upper surface of the base body 341 at a position corresponding to the elastic driving member 33 is provided with a positioning portion 344 which protrudes upwardly in form of cone-shape, the positioning portion 344 cooperates with and positions the elastic driving member 33, is used to retain position stability of the elastic driving member 33. The elastic contact arm 342 is connected to the base body 341 and extends toward the supporting element 32 relative to the base body 341. The conductive base 34 further includes a connecting leg 343, the connecting leg 343 extends toward an outer side of the base body 341 relative to the base body 341, could be connected with the circuit board 4 by soldering. The base body 341 is electrically connected with the circuit board 4 via the connecting leg 343. The conductive base 34 is integrally formed by stamping a metal sheet and realizes a stable and reliable electrical connection between the supporting element 32 and the circuit board 4. In combination with FIG. 3, it may be seen that, in the S2 direction, a width of the base body 341 is larger than a width of the supporting element 32, so that a contact position of the elastic contact arm 342 bends toward an inner side relative to a connecting position of the elastic contact arm 342 with the base body 341. Here, the inner side is a direction that points to an axis of the supporting element 32. Two opposite sides of the base body 341 are provided with the two elastic contact arms 342, after the two elastic contact arms 342 are formed by bending, the two elastic contact arms 342 always have tendency clamping toward the inner side, so that during use, the two elastic contact arms 342 may always embrace an outer wall of the supporting element 32, so that the two elastic contact arms 342 always retain the electrical connection with the outer wall of the supporting element 32, and may retain stable contact effect in a vibrating circumstance.

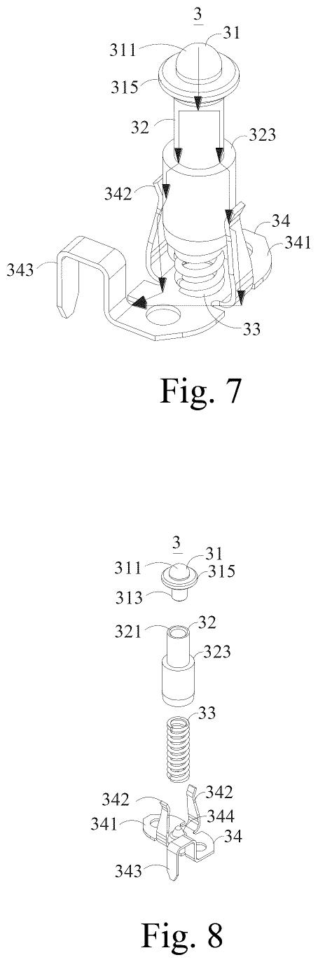

FIG. 7 illustrates a schematic view of an electric current direction when the electrical connector 3 is used. In use, the contact portion 311 may form a contact-type electrical connection with another mating member, when the electrical connector 3 is used to input an electric current from the external, the electric current direction is consistent with an arrow direction of FIG. 7, i.e. the electric current from the external is transferred to the supporting element 32 via the contact portion 311 of the contact member 31, is transferred to the conductive base 34 via a contact point between the supporting element 32 and the elastic contact arm 342, in turn is transferred to the circuit board 4 via the connecting leg 343, when the electrical connector 3 is used to output an electric current toward the external, the electric current direction is opposite to the arrow direction of FIG. 7. When the electrical connector 3 is subjected to action of the mating member, the contact portion 311 and the supporting element 32 move downwardly, compress the elastic driving member 33 to be elastically deformed. The two elastic contact arms 342 of the conductive base 34 respectively clamp two sides of the supporting element 32 and elastically contact with the supporting element 32 together, may establish a good and stable electrical connection, prevent instant break from being generated during vibration, and efficiently promote use stability and reliability of the electrical connector assembly. An elastic contact manner between the two elastic contact arms 342 and the supporting element 32 used by the present disclosure is tighter, is smaller in contact resistance, cooperation between the two elastic contact arms 342 and the supporting element 32 is stabler and may be better adapted to a high electric current transferring scene.

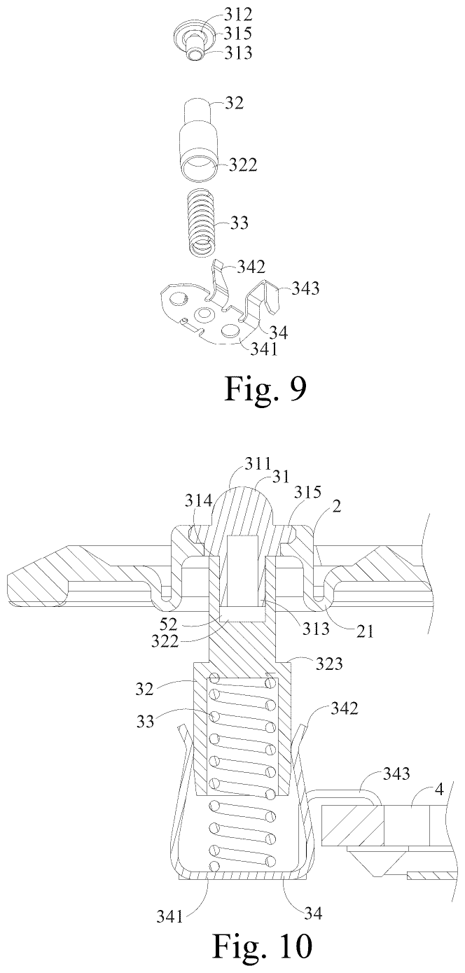

As shown in FIG. 3 and FIG. 9, an outer edge of the contact portion 311 expands outwardly to form a mounting portion 315, an outer diameter of the mounting portion 315 is larger than an outer diameter of the contact portion 311 and an outer diameter of the post 313, the contact member 31 may form tighter and stabler connection with the elastic waterproof member 2. The mounting portion 315 and the post 313 is further provided therebetween with a neck portion 312 which is recessed toward the inner side, the elastic waterproof member 2 are partially filled to an outer periphery of the neck portion 312, so that the connecting tightness between the elastic waterproof member 2 and the contact member 31 may be further promoted, and a better waterproof effect is attained. The upper side of the supporting element 32 may abut against the elastic waterproof member 2, to further promote sealing performance of the electrical connector 3.

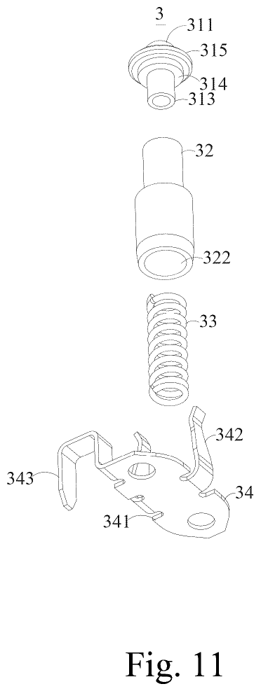

FIG. 10 and FIG. 11 are partial schematic views of an electrical connector assembly of a second embodiment of the present disclosure. The second embodiment differs from the first embodiment in that structures and a cooperating manner between the contact member 31 and the supporting element 32 have differences. In the second embodiment, the mounting portion 315 and the post 313 of the contact member 31 is further provided therebetween with a first step portion 314, the first step portion 314 presses against an upper edge of the supporting element 32, the supporting element 32 functions as supporting and fixing the contact member 31. A bottom portion of the post 313 and a bottom surface of the first receiving groove 321 therebetween form a second gap 52 in the first direction, the second gap 52 may be reserved to permit an assembling tolerance between the contact member 31 and the supporting element 32 and lower an assembling precision requirement on the contact member 31 and the supporting element 32. In other implementing manner not shown, the first step portion 314 may also be provided as an annular recessed groove which is recessed inwardly, and the elastic waterproof member 2 may further enter the annular recessed groove, so that the cooperation between the elastic waterproof member 2 and the contact member 31 is stabler.

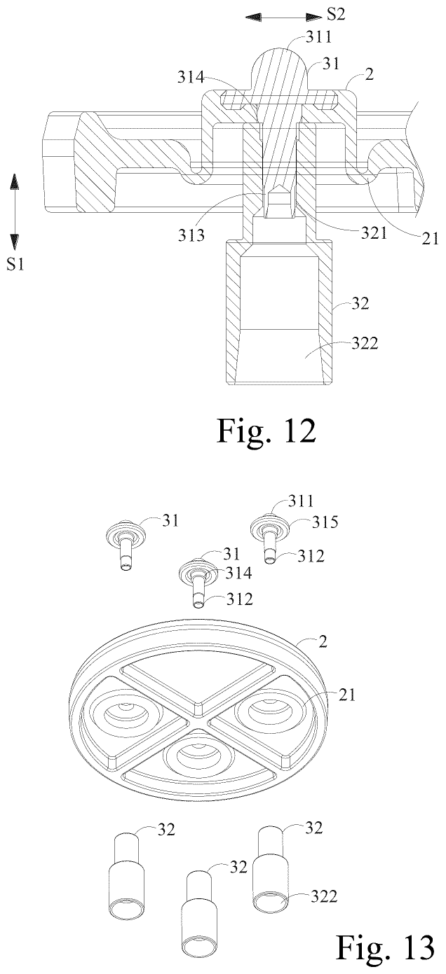

FIG. 12 and FIG. 13 are partial schematic views of an electrical connector assembly of the third embodiment of the present disclosure. The third embodiment differs from the first embodiment in that, in the third embodiment, the mounting portion 315 and the post 313 of the contact member 31 is further provided therebetween with a first step portion 314, the first step portion 314 presses against an upper side of the supporting element 32, and relative positions between the contact member 31 and the supporting element 32 in the first direction are limited by the first step portion 314. At the same time, the first receiving groove 321 and the second receiving groove 322 are communicated with each other to form a through hole which penetrates up and down. The post 313 of the contact member 31 and the first receiving groove 321 therebetween form an interference fit. The post 313 of the contact member 31 may be designed longer, a part of the post 313 which extends downwardly and enters the first receiving groove 321 is more, so that stability of cooperation between the contact member 31 and the supporting element 32 in the radial direction is promoted.

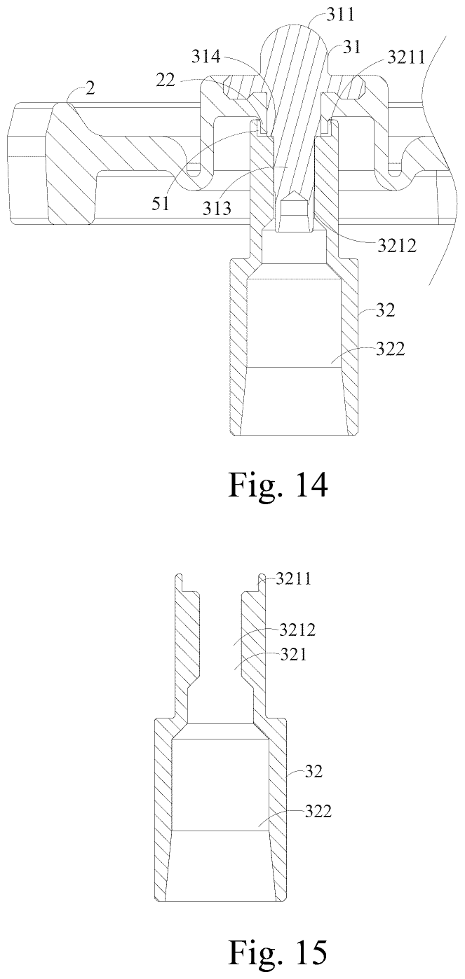

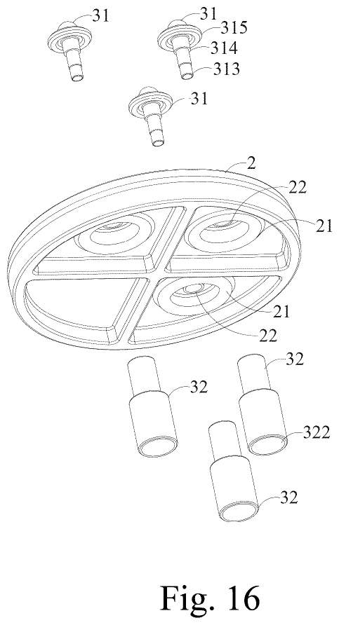

FIG. 14 to FIG. 16 are partial schematic views of an electrical connector assembly of a fourth embodiment of the present disclosure. The fourth embodiment differs from the first embodiment in that, in the fourth embodiment, the mounting portion 315 and the post 313 of the contact member 31 is further provided therebetween with a first step portion 314, the first step portion 314 presses against an upper side of the supporting element 32, and relative positions between the contact member 31 and the supporting element 32 in the first direction are limited by the first step portion 314. The first receiving groove 321 of the supporting element 32 includes an opening section 3211 whose inner diameter is larger and a receiving section 3212 whose inner diameter is smaller, the opening section 3211 is positioned to an upper side of the receiving section 3212, the receiving section 3212 and the second receiving groove 322 are communicated with each other. A lower half of the first step portion 314 is positioned in the opening section 3211, and the first step portion 314 presses against a bottom surface of the opening section 3211, the post 313 is tightly fixed to the receiving section 3212.

In the fourth embodiment, an inner wall of the opening section 3211 and the first step portion 314 form a first gap 51 in the radial direction, a lower portion of the elastic waterproof member 2 has a protruding portion 22 which is positioned in the first gap 51, so that the elastic waterproof member 2 has a longer engagement length in the up-down direction with the contact member 31, the sealing effect of the elastic waterproof member 2 on the electrical connector 3 is further promoted. A bottom surface of the protruding portion 22 and the bottom surface of the opening section 3211 therebetween form a third gap in the first direction, which avoids the elastic waterproof member 2 blocking the contact member 31 to sufficiently insert into the supporting element 32. In another alternative implementing manner not shown, the bottom surface of the protruding portion 22 may also press against the bottom surface of the opening section 3211, to promote cooperation between the elastic waterproof member 2 and the supporting element 32.

The above content is a further detailed description of the present disclosure based on specific preferred embodiments, and it cannot be considered that the specific implementation of the present disclosure is limited to these descriptions. For ordinary technical personnel in the technical field to which this application belongs, without departing from the concept of the present disclosure, several simple deductions or substitutions can be made, which should be considered as within the scope of protection of the present disclosure.

What is claimed is:

1. An electrical connector assembly, comprising:
an elastic waterproof member; and
at least one electrical connector provided to the elastic waterproof member, the electrical connector comprising:
a contact member partially exposed to a first side of the elastic waterproof member along a first direction, the contact member is integrated with the elastic waterproof member;
a supporting element provided to a second side of the elastic waterproof member along the first direction, the supporting element and the contact member being fixed together and establishing an electrical connection;
a conductive base comprising at least one elastic contact arm, the elastic contact arm and the supporting element slidably contacting each other to form an electrical connection; and
an elastic driving member provided between the conductive base and the supporting element, the contact member and the supporting element being capable of moving along the first direction relative to the conductive base by means of the elastic driving member.

2. The electrical connector assembly according to claim 1, wherein the conductive base comprises a base body, the base body is provided to a side of the supporting element away from the contact member, and the elastic driving member is provided between the base body and the supporting element and the elastic contact arm is connected to the base body, and extends toward the supporting element relative to the base body.

3. The electrical connector assembly according to claim 2, wherein the at least one elastic contact arm are two elastic contact arms, the two elastic contact arms respectively clamp two opposite sides of the supporting element.

4. The electrical connector assembly according to claim 2, wherein the electrical connector assembly further comprises a circuit board, a connecting leg further extends out from the base body, the base body is electrically connected with the circuit board via the connecting leg.

5. The electrical connector assembly according to claim 4, wherein the circuit board is provided with a receiving hole, at least a part of the conductive base is positioned in the receiving hole, and the connecting leg extends toward an outer side of the base body relative to the base body.

6. The electrical connector assembly according to claim 2, wherein the conductive base is integrally formed by stamping a metal sheet, and the base body is provided with a positioning portion which protrudes upwardly at a position of the base body corresponding to the elastic driving member, and the positioning portion is used to cooperate with and position the elastic driving member.

7. The electrical connector assembly according to claim 2, wherein the supporting element is provided with a first receiving groove and a second receiving groove, and at least a part of the contact member is positioned in the first receiving groove, and at least a part of the elastic driving member is positioned in the second receiving groove.

8. The electrical connector assembly according to claim 1, wherein the contact member comprises a contact portion which is positioned to the first side and is dome-shaped and a post which is positioned to the second side, and a first side of the supporting element forms a first receiving groove, and at least a part of the post of the contact member is positioned in the first receiving groove.

9. The electrical connector assembly according to claim 8, wherein an outer edge of the contact portion expands outwardly to form a mounting portion, and the contact portion and the post is further provided therebetween with a neck portion which is recessed inwardly, the elastic waterproof member is filled to an outer periphery of the neck portion.

10. The electrical connector assembly according to claim 8, wherein the contact portion and the post of the contact member is further provided therebetween with a first step portion, the first step portion presses against the first side of the supporting element.

11. The electrical connector assembly according to claim 8, wherein the contact portion and the post of the contact member is further provided therebetween with a first step portion, and the first receiving groove comprises an opening section whose inner diameter is larger and a receiving section whose inner diameter is smaller, the opening section is positioned to a first side of the receiving section, and the first step portion presses against a bottom surface of the opening section, and the post is tightly fixed to the receiving section.

12. The electrical connector assembly according to claim 11, wherein an inner wall of the opening section and the first step portion form a first gap in a radial direction, the elastic waterproof member comprises a protruding portion which is positioned in the first gap.

13. The electrical connector assembly according to claim 1, wherein a first side of the supporting element abuts against the elastic waterproof member.

14. The electrical connector assembly according to claim 1, wherein the elastic waterproof member comprises a plurality of U-shaped elastic extending portions, the plurality of elastic extending portions are positioned to an outer side of the electrical connector.

15. The electrical connector assembly according to claim 1, wherein the electrical connector assembly further comprises an outer casing, and the elastic waterproof member is fixed to an outer surface of the outer casing, and at least a part of the electrical connector is positioned inside the outer casing, and the supporting element is provided with a second step portion, and the outer casing is provided with a limiting portion which faces the second step portion, and the limiting portion is positioned to a side of the second step portion which is toward the contact member.
